(19) United States
(12) Patent Application Publication
(10) Pub. No.: US 2016/0091971 A1
(43) Pub. Date: Mar. 31, 2016

(54) REAR TOUCHSCREEN HAVING DYNAMIC FINGER REGISTRATION

(71) Applicant: Jeremy Burr, Portland, OR (US)

(72) Inventor: Jeremy Burr, Portland, OR (US)

(21) Appl. No.: 14/497,528

(22) Filed: Sep. 26, 2014

(51) Int. Cl. G06F 3/01; G06F 3/041; G06F 3/0482; G06F 3/0484; G06F 3/0488

(52) U.S. Cl. CPC G06F 3/016; G06F 3/04842; G06F 3/04886; G06F 3/0482; G06F 3/041

(57) ABSTRACT

Systems and methods may provide a dynamically adjustable array of tactile elements on the back of a computer tablet. When an application running on the tablet requests user input at one or more locations on the display, these locations may be mapped onto corresponding tactile elements on the back of the tablet and the user may then engage the locations by touch instead of providing input on the display. The particular set of tactile elements chosen in the mapping may be altered to suit the application and the preferences of the user. In one embodiment, the tactile elements are groups of inflatable buttons that may readily be felt by the user.

### BACKGROUND

Tablet computers, two-in-one notebook computers, smart phones and similar devices have front panel, forward-facing displays that may further be provided with overlying touchscreens. Users may interact with these devices through icons appearing on the display by pressing down on the touchscreen in areas that are in registry with the icons. The touchscreen may further provide a tactile, i.e., a haptic component, so that it may be further felt through the sense of touch as well as seen.

The ergonomics of providing such interactions through a forward facing display may hamper other aspects of using the device, including holding the device while attempting to press down on the screen icons. Often, when holding a table with two hands, it may be difficult to navigate on the front panel touchscreen because the user's fingers may obscure the icons. Also, such devices are typically held with the thumbs of the user's hands in front and the opposing fingers resting against the back panel. The user may fail to maintain an adequate grip on the device while attempting to touch the appropriate icon on the screen. As a result, the user may drop the device and damage the display, which may be expensive to repair or replace.

### BRIEF DESCRIPTION OF THE DRAWINGS

The various advantages of the embodiments will become apparent to one skilled in the art by reading the following specification and appended claims, and by referencing the following drawings, in which:

FIGS. 1A and 1B are front and rear views respectively of an example of an embodiment;

FIG. 2 is a rear view of an example of an embodiment having a keyboard;

FIGS. 3A-3C provide a rear view of an example of an embodiment having dynamically addressable tactile elements;

FIG. 4 is a flowchart of an example of a method of controlling tactile elements according to an embodiment;

FIG. 5 is a block diagram of an example of an architecture to control tactile elements according to an embodiment; and

FIG. 6 is a view of an example of tactile elements utilizing fluidics and a block diagram of a control system according to an embodiment.

### DETAILED DESCRIPTION

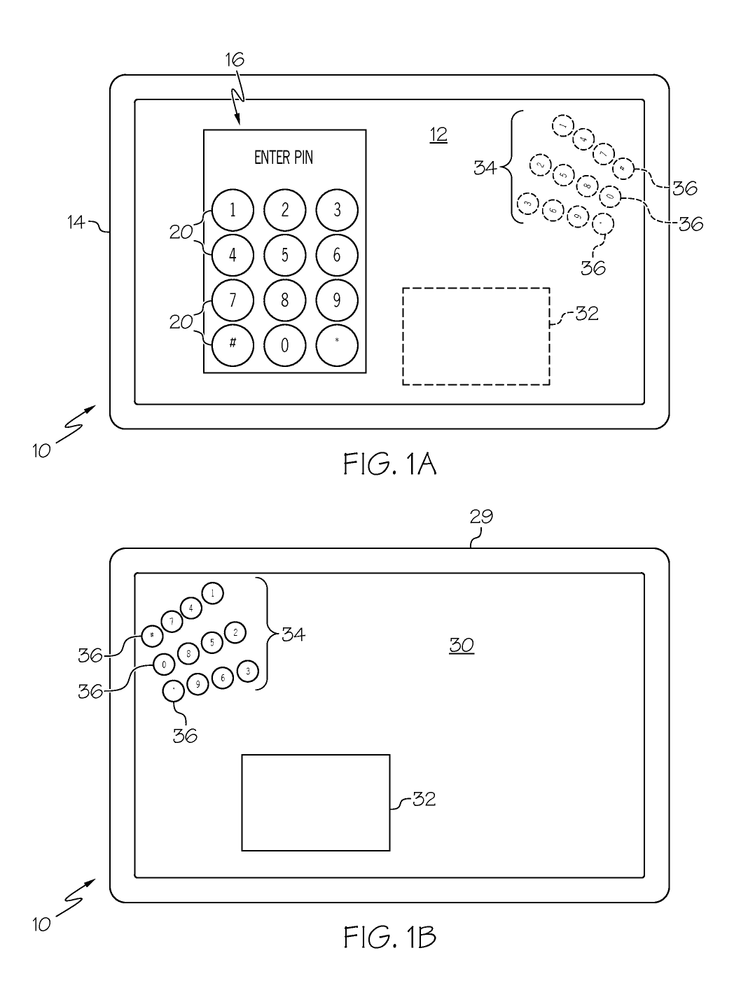

FIG. 1A depicts a front panel, forward facing side of a computer tablet 10 constructed according to an embodiment. This side has a display 12 bound by a bezel 14. The tablet 10 may be running an application that generates a graphical element 16 (here depicting a keypad) shown as a request to enter a personal identification number, or PIN, along with a keypad of buttons 20 located on the display. The user may choose to press down on the display 12 to enter these numbers on an overlying touchscreen where one is provided, but such an approach may prove awkward in terms of handling the tablet 10.

In the illustrated embodiment, a back panel surface 29 of the tablet is provided with a touchscreen 30 as shown in FIG. 1B. A group 34 of tactile elements 36 may be provided and arrayed towards the edge of the touchscreen 30. The individual tactile elements 36 of the array 34 may correspond to the individual buttons 20 on the keypad of the graphical element 16. In this embodiment, the tactile elements 36 are arranged in generally arcuate, radial rows so that the four fingers opposite the thumb may curl behind the tablet and press down on them while the thumb grips the tablet from the front along the bezel 14. FIG. 1A illustrates the tactile elements on the back in phantom. Additionally, a portion of the touchscreen may include a trackpad 32 (FIG. 1B).

As used herein, the term “tactile element” may refer to an element providing tactile feel when it is used, i.e., located, touched or depressed. In general terms, the tactile elements have the property that when they are in an active state, they may assume a characteristic that enables a user to differentiate it from the surrounding area and so provide tactile registry with the fingers of the user. In one embodiment, such an approach may be accomplished by extending a portion of the element beyond its immediate neighboring area when activated. In one embodiment, the tactile element may include a diaphragm overlying a cavity that may be filled with a fluid, causing the diaphragm to bulge outwardly when the tactile element is energized, giving it a bubble-like “button” shape and feel to the touch. When the tactile element is de-activated and returned to its resting state, fluid may flow out of the cavity, causing it to deflate and provide the tactile element with a feel that is largely the same as the surrounding area of the device.

Tactile elements may be grouped into rows, columns, arrays, concentric circles or any other shape that is suitable for the embodiment and application with which they are used. The tactile elements may range from sub-millimetric in size to dimensions in excess of centimeters or more. In embodiments in which fluidic inflation is used, the tactile elements are generally round and may herein be referred to as “buttons”. In other embodiments they may be rectangular, pin-like or have other shapes.

In some embodiments (such as the example provided in FIGS. 1A and 1B), the tactile elements may be grouped near the sides of the tablet as at such locations they may readily be reached when the user extends his fingers. However, in other embodiments, the tactile elements may be located further towards the center, top, or bottom of the back of the tablet.

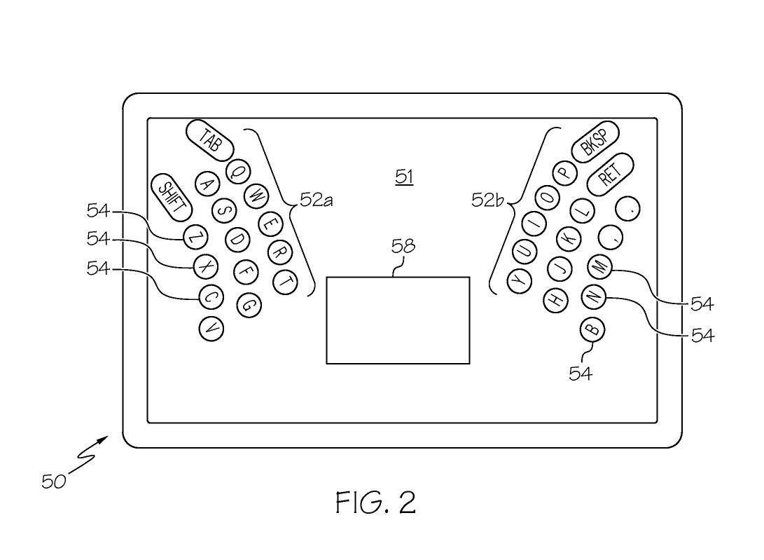

A given application running on a tablet may provide or make use of a full keyboard on its display. However, in addition to possibly being awkward to use while gripping the tablet, the provision of a full keyboard on a display also may use up a great deal of the available display space. Embodiments disclosed herein may increase the space available on the display by moving the keyboard to the back panel of the tablet, freeing up the display space for other things. For example, FIG. 2 depicts an example of an embodiment in which a tablet 50 has a touchscreen 51 on its back panel on which are arranged two arrays 52a and 52b of tactile elements 54. Together, the arrays 52a, 52b form a QWERTY keyboard. A portion of the touchscreen 51 may be used as a trackpad 58. This arrangement gives the user access to a full keyboard on the back of the tablet and to touch-type while securely gripping the tablet 50 with both hands, as the fingers that may be used to touch the keys are normally arrayed along the back panel anyway.

In some embodiments, only a portion of the touchscreen is provided with tactile elements, and essentially all of the elements provided (the twelve tactile elements 36 that make up the keypad in FIG. 1B, and the thirty two tactile elements that form the QWERTY keyboard in FIG. 2) may be utilized. However, in other embodiments, a larger number of tactile elements may be provided along the touchscreen, and in some embodiments an array of them may cover substantially the entire surface of the touchscreen. In the embodiments, a subset of the tactile elements may be put into an active state (such as by inflating individual button-type tactile elements) and the particular location of a group of active tactile elements of interest may be dynamically shifted along the touchscreen. According to one embodiment, the particular mapping of graphical elements (e.g. letters, numerals, special characters, etc.) on the display to the tactile elements may be dynamically varied, i.e., altered, to accommodate the particular application running on the tablet. For example, instead of a QWERTY keyboard as shown in FIG. 2, a non-standard keyboard may be used, or a keyboard may be shifted to another location along the back of the tablet to better suit the hand size of the user.

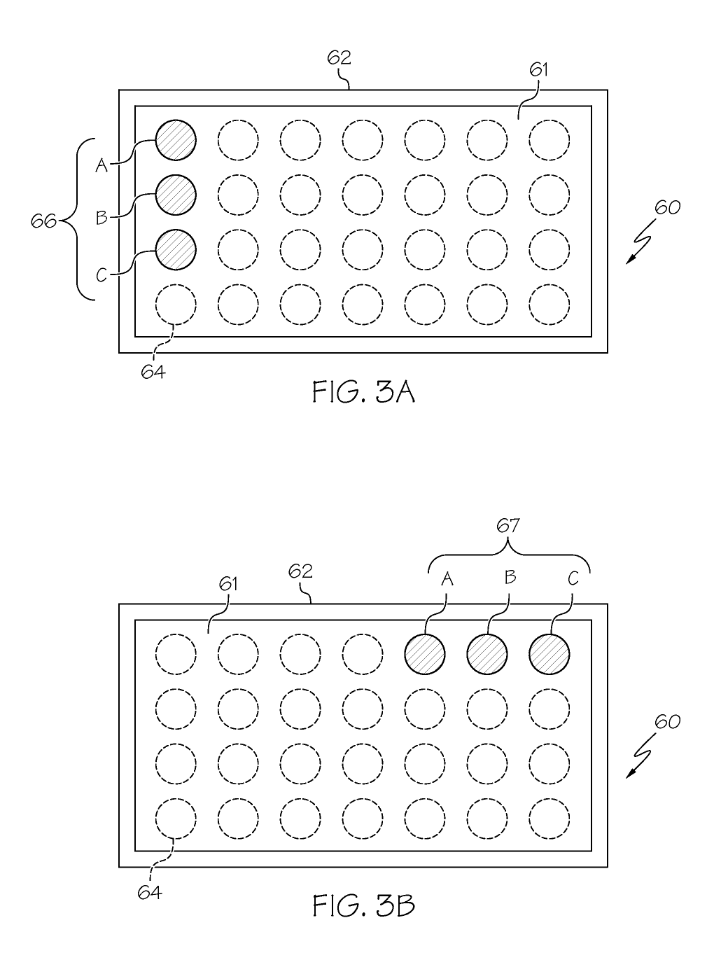

FIGS. 3A-3C illustrate an example of an embodiment having dynamically variable tactile elements to accommodate different locations for facilitating finger registration. The tablet 60 may have a touchscreen 61 on its back panel 62. The illustrated touchscreen 61 is essentially covered with individual tactile elements 64 that begin in an inactive state (here indicated with broken lines), but which may selectively be activated for use in creating a custom user interface that may be dynamically varied. For example, the application running on the tablet may entail the use of three keys for the user to depress: A, B and C. In this case, only three of the tactile elements 64 need be activated (e.g., inflated, in the case of fluidic tactile elements). The particular choice of which three to use for this purpose may be variable. Here, three different possible groups of tactile elements A, B and C are shown. In FIG. 3A, the tactile elements are a vertical group 66; in FIG. 3B, the tactile elements are grouped horizontally at 67; in FIG. 3C, the tactile elements are grouped diagonally at 68. The choice of which to use may be left to the user or it may be selected by the particular application.

In a further embodiment, when a tactile element is depressed, the corresponding graphical element (e.g., a numeral or a letter) is mapped onto the display. This arrangement provides the user with direct feedback in two forms. Firstly, the tactile aspect of the tactile elements is useful for placing the user's fingers into proper registry with the tactile elements on the back of the tablet. Secondly, the mapping of the identity of the particular tactile element depressed onto the front facing screen may show the user which tactile element has been pressed in real time, enabling him to correct any mistakes.

In some embodiments, all of the active elements may be projected onto the display, along with an indication of when they have been depressed. The displayed active elements may be arranged on the display in a more compact, linear fashion than what is actually deployed on the rear of the tablet. Indeed, the ability of embodiments to allocate tactile elements on the back panel of a tablet independently of how they may be depicted on the forward-facing display screen helps optimize the usage of each according to the needs and preferences of the user and the application.

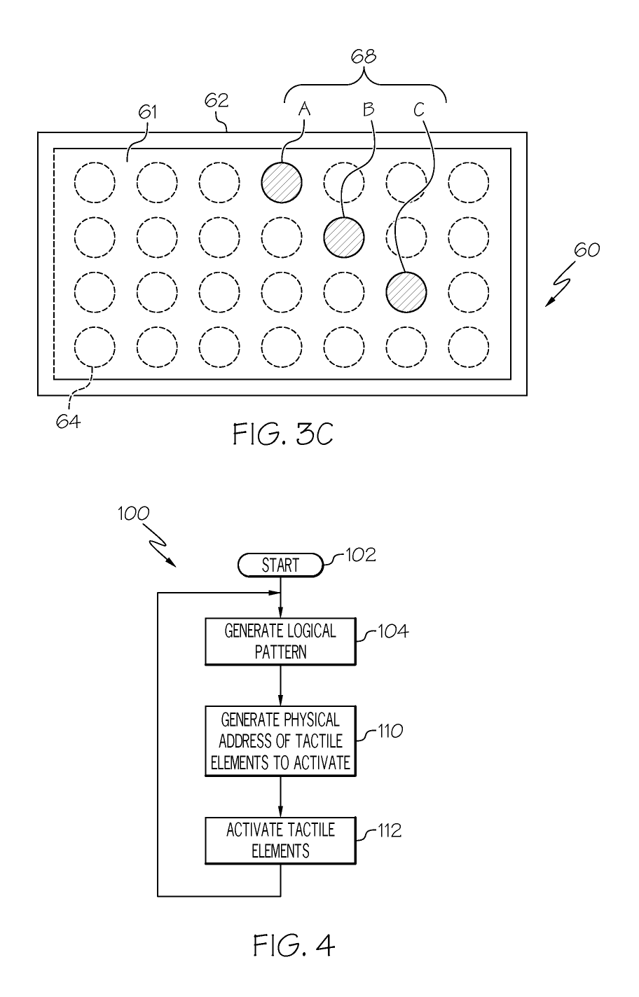

Turning to flow chart 100 in FIG. 4, one example of a method to dynamically utilize tactile elements on a back touchscreen is shown. The method 100 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

At starting block 102, the user or an application initiates a request that a logical pattern of activated tactile elements be generated at illustrated block 104. The logical pattern may correspond to a numeric keypad, a full QWERTY keyboard, or some other configuration of use to the application at hand. The activated tactile elements may be mapped onto physical addresses or locations of tactile elements at block 110, and at illustrative block 112 these tactile elements are activated, i.e., placed in a state from which they may be distinguished from surrounding portions of the screen by a user's sense of touch. The pattern thus established may be constant, or it may be varied by again generating a logical pattern at block 104.

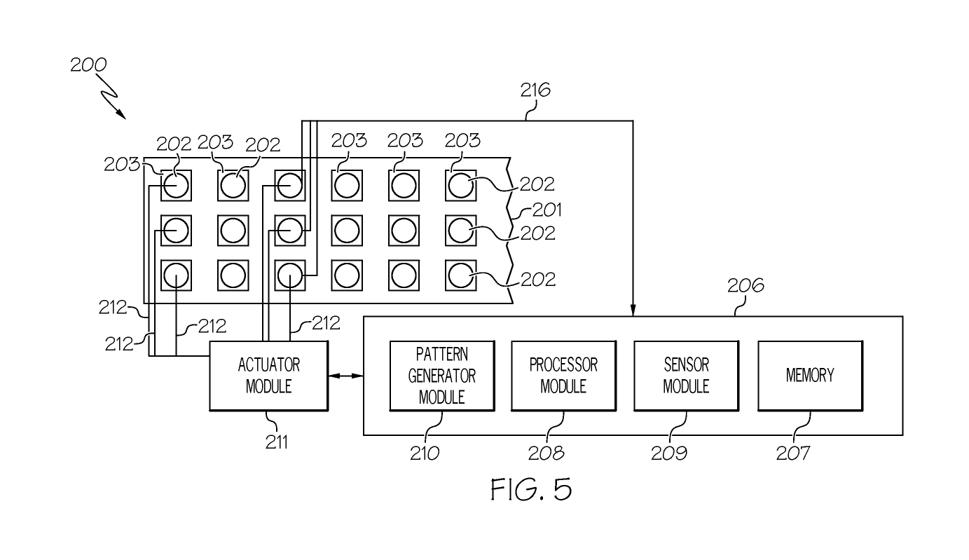

FIG. 5 is a block diagram 200 of an example of an architecture for providing dynamic control over an array of tactile elements and through which a user interface may be established. The example of FIG. 5 includes a schematic illustration of touchscreen 201 on which is a group of rows (there may be more or fewer) of tactile elements 202. Associated with each tactile element 202 is a corresponding sensor 203 responsive to pressure or temperature such as is characteristic of touch by a user's finger, or any other physical variable that may be associated with a user that may be brought into proximity with the sensors, which may be integrated into the backing touchscreen 201. The tactile elements 202 in this example overlie the sensors 203, although this order may be reversed. In this example, each tactile element 202 is individually addressable and controllable via lines 212. In other embodiments, control may be over less granular groups of tactile elements, such as rows or columns or portions thereof. Additionally, each sensor 203 may have a return line 216.

A control module 206 may direct an actuator module 211 to activate, via control lines 212, one or more of the tactile elements 202. The particular nature of the actuator module 211 may depend on the specific implementation of tactile element used. For example, if the tactile elements are implemented as fluidicly activated buttons, then the actuator module 211 may include at least one pump, which may be bidirectional, and may also include fluidic logic in the form of valves and fluid circuits to permit the selective activation and deactivation of individual or groups of tactile elements. The actuator module 211 may also include a reservoir of hydraulic fluid. In such an example, the control lines 212 use pressurized fluid. In another example, the tactile elements may be based on solenoids, wherein the actuator module 211 may include electrical circuitry to selectively activate and deactivate desired tactile elements via control lines 212 that are electrically conductive. The control lines 212 in this example are electrically conducting wires. Whatever the specific form of tactile element used, the actuator module 211 may activate a specific physical pattern of tactile elements 202.

In this example, the physical pattern identifies specific tactile elements 202 for activation. The physical pattern may be generated within the control module 206, which may include a memory module 207, a processor module 208, a sensor module 209, and a pattern generator module 210. The memory module 207 may store context information and rules, pre-set logical patterns of activations, applications and application data, and sensor data. The illustrated processor module 208 processes any or all of this information, resulting in the generation of a logical pattern of tactile element activations. This logical pattern may be turned into (i.e., map onto) a physical pattern of activations at the pattern generator module 210. The sensor module 209 may include and process sensor data.

In operation, the user may apply pressure to the activated tactile elements 202 (which, in the examples of the solenoid or fluidics embodiments, would be protruding when activated), causing switching or other sensory input into the associated sensors 203, which may also be switches. These sensors 203 may then send signals conveying information via lines 216 to the control module 206, providing feedback and/or other data, although open loop control may be practiced in other examples. After a predetermined time interval, the tactile elements 202 may be de-activated for later re-use, and return to their initial configuration in which they feel generally flush with the surrounding area. In alternative embodiments the memory module 207, processor module 208, sensor module 209 and pattern generator module 210 may be combined into fewer modules.

The sensors 203 may be digital, in that they record the pressure sensed at the sensor as having only two binary states (e.g., “on” versus “off”), while in other embodiments the sensors may provide multiple levels of response so that the amount of pressure applied to the tactile elements may be more granular, providing an analog measure.

Embodiments disclosed herein provide for a dynamically programmable array of tactile elements in which a physical pattern of tactile elements to be placed into an activated or a de-activated state may be based on a logical pattern of tactile elements. Each of these patterns may be varied as per the needs of the user and/or the requirements of whichever application the user may be running at a given time.

The flexibility provided by the programmability of the tactile elements may afford both the user and/or the application designer broad scope in crafting user interfaces. For example, a number of tactile elements could be activated together to form a larger button for the benefit of users with larger fingers.

A number of different technologies may be used in implementing the touchscreen and the tactile elements. Examples of touchscreen technologies that may be employed include fluidics, resistive touchscreens, surface acoustic wave technology touchscreens that may employ a microphone, touchscreens that utilize ultrasonic waves, capacitive touchscreen panels, touchscreen panels based on projected capacitance, optical imaging, dispersive signal technology, acoustic pulse recognition, and infrared grids.

Examples of haptic technologies that may be used in implementing the tactile elements include systems based on vibratory mechanism such as vibratory motors, electroactive polymers, piezoelectric, electrostatic and subsonic audio wave surface actuation, audio haptics, fluidics, and reverse-electrovibration systems. These may be binary, or they may offer pressure sensitivity to measure in a more analog fashion how hard a user is engaging the tactile element.

As noted above, fluidics may be employed to control and activate tactile elements. In one embodiment, the tactile elements are provided as an array of buttons formed of a substrate attached to a button membrane, thereby creating a set of round, button cavities. The button cavities may be configured to be inflated and deflated by a pump coupled to a fluid reservoir. The cavities may be inflated/deflated together, in subsets, and/or individually. In some embodiments, the buttons may be sandwiched between a touch sensing layer and a display of a touch screen. In other embodiments, the button array may be located either above or below the touch screen.

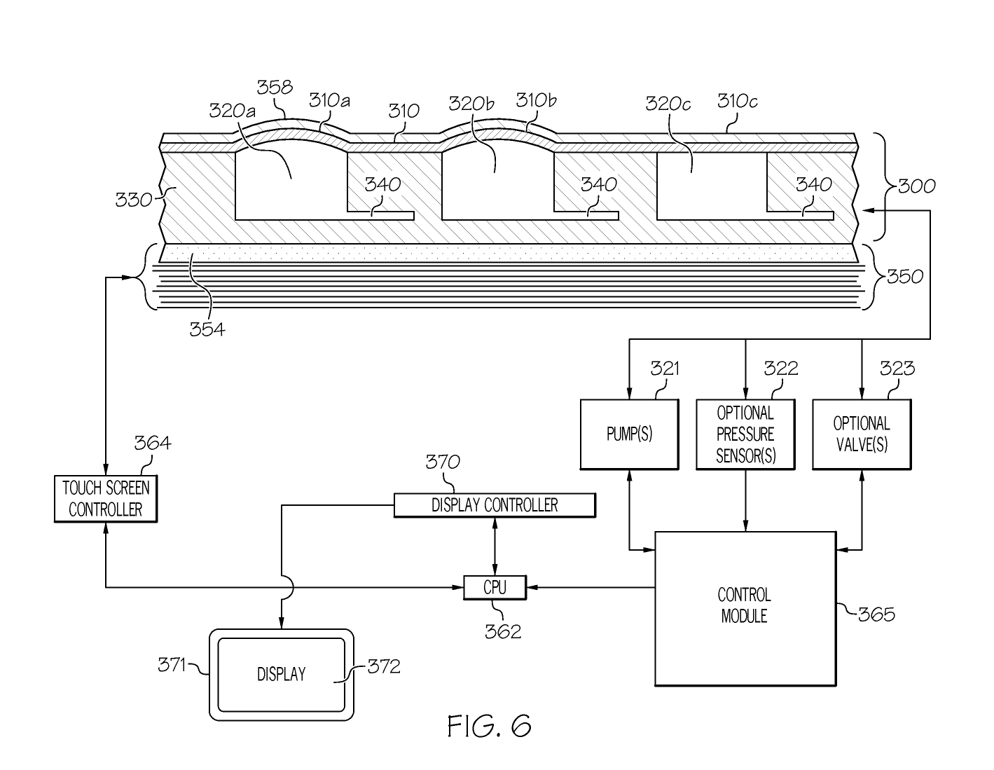

An embodiment utilizing fluidics is shown in FIG. 6. In the illustrated example, a button array 300 includes a substrate 330 and an overlying membrane 310 which are coupled to each other to form one or more enclosed cavities 320a, 320b, and 320c and overlying membrane portions 310a, 310b, and 310c. Substrate 330 may be made from a suitable flexible material including elastomers. In some embodiments, the substrate 330 is a single homogenous layer approximately 1 mm to 0.1 mm thick and may be manufactured using well-known techniques for micro-fluid arrays to create one or more cavities and/or micro channels.

The membrane 310 may be made from a suitable optically transparent and elastic material including polymers or silicon-based elastomers such as polydimethylsiloxane (PDMS) or polyethylene terephthalate (PET).

The enclosed cavities 320a, 320b, and 320c, formed between substrate 330 and membrane 310, may be fluid tight and coupled via fluid channel 340 to one or more fluid pumps (not shown in this figure). The pump(s) may either be internal or external with respect to a touch screen assembly incorporating button array 300.

When selected buttons of the button array 300 need to be activated, i.e., raised or in other words inflated, fluid pressure inside specific cavities—here 320a and 320b—is increased thereby causing the overlying membrane portions 310a and 320b to be raised. In this example, the third cavity, 320c is not pressurized because it is not in an active state, and its overlying membrane 310c remains flat. In this example, which is suitable for a handheld device, cavities 320 may have a cavity diameter of approximately 5 mm or may be larger, and membrane 310 is approximately 100 microns thick. Conversely, when button array 300 needs to be deactivated, fluid pressure inside the cavities is decreased thereby causing them to deflate and their corresponding overlying membrane portions (in this instance, 310a and 320a) to return to their original flat profile. It is contemplated that a button fluid pressure of approximately 0.2 psi and a button fluid displacement of about 0.03 ml should be sufficient to raise selected membrane (button) portions of 310 by about 1 mm.

The buttons may be located atop a touchscreen 350 and may optionally include a sensor layer 354.

According to another embodiment, an overlying infrared sensor layer 358 may be provided to provide for finger proximity detection. The buttons are provided with infrared sensors in layer 358 so that they are able to sense the temperature of a finger approaching the buttons or hovering over them, enabling them to be inflated just moments before actual contact is made. Such an approach may be advantageous in some circumstances where it may be used because activating a button uses energy, and by limiting the time that the buttons are activated to the typically brief interval when the user's fingers are nearly touching the buttons until after they have left them reduces power consumption. In another embodiment, projected capacitance may be used in the touchscreen to provide such detection capability.

Although several of the previous embodiments have been illustrated in terms of tablet computers, embodiments may be utilized in gaming devices as well.

FIG. 6 also presents an example of a control system for fluidic buttons/tactile elements according to an embodiment. The example may include a central processing unit 362, a touchscreen controller 364 coupled to the touchscreen to determine when a button has been pushed, and a display controller 370 coupled to a tablet 371 having a display 372. Activation of the buttons may be controlled by control module 365 (which may be similar to the control module 206 of FIG. 5). The illustrated control module 365 creates a logical pattern of activations that is implemented physically by one or more pumps 321 (which may be bidirectional) sending pressurized fluid into selected button cavities 320a, 320b, and 320c as set forth above. Depending on the embodiment, the implementation may also include fluid pressure sensor(s) 322 and valve(s) 323 coupled to pump(s) 321.

In some embodiments, not every tactile element may be individually activatable, but the tactile elements may instead be activated in groups.

Additional Notes and Examples:

Example 1 may include an electronic device comprising a front side having a display, a back side having a plurality of tactile elements, logic, implemented at least partly in fixed-functionality hardware, to determine whether an application requests user input at one or more graphical elements appearing on the display, map said graphical elements to corresponding tactile elements on the back side of the electronic device, and determine user engagement of said tactile elements.

Example 2 may include the electronic device of Example 1, wherein the logic is to create a map of said graphical elements to corresponding tactile elements, and wherein said map is dynamically alterable.

Example 3 may include the electronic device of Example 2, wherein the map is dynamically alterable in dependence upon one or more of a user input or an application.

Example 4 may include the electronic device of Example 2, further comprising a touchscreen overlying at least a portion of the back side, and wherein the tactile elements are to be connected to the touchscreen.

Example 5 may include the electronic device of Example 4, wherein the touchscreen comprises sensors to detect one or more of touch or temperature.

Example 6 may include the electronic device of Example 4, wherein the sensors are to provide more than two levels of measurement.

Example 7 may include the electronic device of Examples 2, 4, or 5, wherein the logic is to map tactile elements on the back side selected by a user to graphical elements on the display.

Example 8 may include the electronic device of Example 7, wherein the tactile elements depict a keyboard.

Example 9 may include the electronic device of Examples 2-6, wherein the tactile elements comprise a chamber configured to contain a quantity of pressurizable fluid, the chamber having an overlying flexible portion to bulge out when the fluid is pressurized, the electronic device further comprising at least one fluid reservoir in fluidic communication with the tactile elements and at least one pump to pressurize the fluid.

Example 10 may include a method to interface with an electronic device, comprising determining whether an application running on an electronic device requests user input at one or more graphical elements appearing on a display on a front side of the electronic device, mapping said graphical elements to corresponding tactile elements on a back side of the electronic device, and placing the corresponding tactile elements into a state where they may be engaged by a user using touch.

Example 11 may include the method of Example 10, further including altering the mapping in dependence upon one or more of a user input or the application.

Example 12 may include the method of Examples 10-11, further comprising detecting at a tactile element one or more of pressure or temperature.

Example 13 may include the method of Examples 10-11, further comprising mapping tactile elements engaged by a user to graphical elements on the display.

Example 14 may include the method of Examples 10-11, wherein the graphical elements are mapped to tactile elements that are grouped near a perimeter of the back side of the electronic device.

Example 15 may include at least one computer readable storage medium comprising a set of instructions which, when executed by a computing device, cause the computing device to determine whether an application running on an electronic device requests user input at one or more graphical elements appearing on a display on a front side of the electronic device, map said graphical elements to corresponding tactile elements on a back side of the electronic device, and place the corresponding tactile elements into a state where they may be engaged by a user using touch.

Example 16 may include the at least one computer readable storage medium of Example 15, wherein the instructions, when executed, cause a computing device to alter the map in dependence upon one or more of a user input or the application.

Example 17 may include the at least one computer readable storage medium of Example 16, wherein the instructions, when executed, cause a computing device to detect one or more of pressure or temperature at a tactile element.

Example 18 may include the at least one computer readable storage medium of Examples 15-16, wherein the instructions, when executed, cause a computing device to map selected tactile elements engaged by a user to graphical elements on the display.

Example 19 may include a system comprising a computer tablet including front side having a display and a back side having a plurality of tactile elements, a processor to generate a logical pattern of tactile elements based on an application, a pattern generator to form a physical pattern of tactile elements to actuate based on the logical pattern, wherein the physical pattern is variable in dependence upon one or more of a user input or the application, and an actuator to activate tactile elements corresponding to the physical pattern so that they may be felt by a user.

Example 20 the system of Example 19, further comprising circuitry to determine whether an application requests user input at one or more graphical elements appearing on the display, and circuitry to determine user engagement of said tactile elements.

Example 21 may include the system of Example 19, further comprising a touchscreen overlying at least a portion of the back side, and wherein the tactile elements are connected to the touchscreen.

Example 22 may include the system of Example 19, wherein the touchscreen comprises sensors to detect one or more of touch or temperature.

Example 23 may include the system of Example 19, further comprising circuitry to map tactile elements selected by a user to graphical elements on the display.

Example 24 may include the system of Examples 19-23, wherein the tactile elements comprise a chamber configured to contain a quantity of pressurizable fluid, the chamber having an overlying flexible portion to bulge out when the fluid is pressurized, further comprising at least one fluid reservoir in fluidic communication with the tactile elements and at least one pump to pressurize the fluid.

Example 25 may include the system of Examples 19-23, wherein the tactile elements overly a touchscreen, and wherein the touchscreen includes sensors to detect a touch to the tactile elements.

Example 26 may include a portable electronic device comprising a front side having a display, a back side having a plurality of tactile elements, means for determining whether an application requests user input at one or more graphical elements appearing on the display, means for mapping said graphical elements to corresponding tactile elements on the back side of the electronic device, and means for determining user engagement of said tactile elements.

Example 27 may include the portable electronic device of Example 26, wherein the map is dynamically alterable.

Example 28 may include the portable electronic device of Example 27, wherein the map is dynamically alterable in dependence upon one or more of a user input or an application.

Example 29 may include the portable electronic device of Examples 27-28, further comprising a touchscreen overlying at least a portion of the back side, and wherein the tactile elements are connected to the touchscreen.

Example 30 may include the portable electronic device of Example 29, wherein the touchscreen comprises means for detecting one or more of touch or heat or infrared radiation.

Example 31 may include the portable electronic device of Example 27, further comprising analog sensors.

Example 32 may include the portable electronic device of Example 27, further comprising digital sensors.

Example 33 may include the portable electronic device of Example 26, wherein the tactile elements comprise a numeric keypad.

Example 34 may include the portable electronic device of Example 26, wherein the tactile elements comprise a full keyboard.

Example 35 may include the portable electronic device of Example 34, wherein the keyboard is arranged in an arcuate radial fashion into two groups of keys.

Example 36 may include a system to provide a user interface comprising an electronic device having a front facing display and a rear facing back having an array of tactile elements; means for determining whether a software application running on the device is awaiting tactile input on the display; means for translating awaited tactile input into a pattern of active tactile elements on the back; and means for determining if a user has engaged the active tactile elements.

Example 37 may include the system of Example 36, wherein the tactile elements comprise fluid filled chambers.

Example 38 may include the system of Examples 36-37, further comprising a touchscreen underlying the tactile elements.

Example 39 may include the system of Examples 36-37, further comprising a touchscreen overlying the tactile elements.

Example 40 may include the system of Examples 36-37, wherein the pattern of active tactile elements is alterable by a user of the software application.

Example 41 may include a method of activating tactile elements located on a rear face of a computer tablet, comprising generating a logical pattern of tactile elements based on an application running on the tablet; using the logical pattern to define a physical pattern of active tactile elements; engaging active tactile elements; and providing an indication of the tactile elements that have been engaged.

Example 42 may include the method of Example 41, wherein the physical pattern is variable.

Various embodiments and various modules may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

As used herein, the term “fluidic” may encompass the term “microfluidic” and the field of microfluidics, depending on component size.

Example sizes/models/values/ranges may have been given, although embodiments are not limited to the same. As manufacturing techniques mature over time, it is expected that devices of smaller size and smaller tactile element size could be manufactured. In addition, well known electrical or fluidic components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

I claim:

1. An electronic device comprising:
a front side having a display;
a back side having a plurality of tactile elements;
logic, implemented at least partly in fixed-functionality hardware, to:
determine whether an application requests user input at one or more graphical elements appearing on the display;
map said graphical elements to corresponding tactile elements on the back side of the electronic device; and
determine user engagement of said tactile elements.

2. The electronic device of claim 1, wherein the logic is to create a map of said graphical elements to corresponding tactile elements, and wherein said map is dynamically alterable.

3. The electronic device of claim 2, wherein the map is dynamically alterable in dependence upon one or more of a user input or an application.

4. The electronic device of claim 2, further comprising a touchscreen overlying at least a portion of the back side, and wherein the tactile elements are to be connected to the touchscreen.

5. The electronic device of claim 4, wherein the touchscreen comprises sensors to detect one or more of touch or temperature.

6. The electronic device of claim 4, wherein the sensors are to provide more than two levels of measurement.

7. The electronic device of claim 2, wherein the logic is to map tactile elements on the back side selected by a user to graphical elements on the display.

8. The electronic device of claim 7, wherein the tactile elements depict a keyboard.

9. The electronic device of claim 2, wherein the tactile elements comprise a chamber configured to contain a quantity of pressurizable fluid, the chamber having an overlying flexible portion to bulge out when the fluid is pressurized, the electronic device further comprising at least one fluid reservoir in fluidic communication with the tactile elements and at least one pump to pressurize the fluid.

10. A method to interface with an electronic device, comprising:
determining whether an application running on an electronic device requests user input at one or more graphical elements appearing on a display on a front side of the electronic device;
mapping said graphical elements to corresponding tactile elements on a back side of the electronic device; and
placing the corresponding tactile elements into a state where they may be engaged by a user using touch.

11. The method of claim 10, further including altering the mapping in dependence upon one or more of a user input or the application.

12. The method of claim 11, further comprising detecting at a tactile element one or more of pressure or temperature.

13. The method of claim 11, further comprising mapping tactile elements engaged by a user to graphical elements on the display.

14. The method of claim 11, wherein the graphical elements are mapped to tactile elements that are grouped near a perimeter of the back side of the electronic device.

15. At least one computer readable storage medium comprising a set of instructions which, when executed by a computing device, cause the computing device to:
determine whether an application running on an electronic device requests user input at one or more graphical elements appearing on a display on a front side of the electronic device;
map said graphical elements to corresponding tactile elements on a back side of the electronic device; and
place the corresponding tactile elements into a state where they may be engaged by a user using touch.

16. The at least one computer readable storage medium of claim 15, wherein the instructions, when executed, cause a computing device to alter the map in dependence upon one or more of a user input or the application.

17. The at least one computer readable storage medium of claim 16, wherein the instructions, when executed, cause a computing device to detect one or more of pressure or temperature at a tactile element.

18. The at least one computer readable storage medium of claim 16, wherein the instructions, when executed, cause a computing device to map selected tactile elements engaged by a user to graphical elements on the display.

19. A system comprising:
a computer tablet including front side having a display and a back side having a plurality of tactile elements;
a processor to generate a logical pattern of tactile elements based on an application;
a pattern generator to form a physical pattern of tactile elements to actuate based on the logical pattern, wherein the physical pattern is variable in dependence upon one or more of a user input or the application; and
an actuator to activate tactile elements corresponding to the physical pattern so that they may be felt by a user.

20. The system of claim 19, further comprising:
circuitry to determine whether an application requests user input at one or more graphical elements appearing on the display; and
circuitry to determine user engagement of said tactile elements.

21. The system of claim 19, further comprising a touchscreen overlying at least a portion of the back side, and wherein the tactile elements are connected to the touchscreen.

22. The system of claim 19, wherein the touchscreen comprises sensors to detect one or more of touch or temperature.

23. The system of claim 19, further comprising circuitry to map tactile elements selected by a user to graphical elements on the display.

24. The system of claim 19, wherein the tactile elements comprise a chamber configured to contain a quantity of pressurizable fluid, the chamber having an overlying flexible portion to bulge out when the fluid is pressurized, further comprising at least one fluid reservoir in fluidic communication with the tactile elements and at least one pump to pressurize the fluid.

25. The system of claim 19, wherein the tactile elements overly a touchscreen, and wherein the touchscreen includes sensors to detect a touch to the tactile elements.
